(19) United States
(12) Patent Application Publication
(10) Pub. No.: US 2022/0167286 A1
(43) Pub. Date: May 26, 2022

(54) SYNCHRONIZATION BOUNDARY RANDOMIZATION

(71) Applicant: QUALCOMM Incorporated, San Diego, CA (US)

(72) Inventors: Aleksandar DAMNJANOVIC, Del Mar, CA (US); Maarten Menzo WENTINK, Nijmegen (NL); Yisheng XUE, San Diego, CA (US); Jing SUN, San Diego, CA (US); Xiaoxia ZHANG, San Diego, CA (US)

(21) Appl. No.: 17/455,600

(22) Filed: Nov. 18, 2021

Related U.S. Application Data
(60) Provisional application No. 63/117,373, filed on Nov. 23, 2020.

(51) Int. Cl. H04W 56/00; H04W 72/04

(52) U.S. Cl. CPC H04W 56/001; H04W 72/0453

(57) ABSTRACT

Various aspects of the present disclosure generally relate to wireless communication. In some aspects, a wireless communication device may determine a plurality of non-periodic synchronization boundaries for synchronous access of a wireless channel. The wireless communication device may communicate on the wireless channel based at least in part on at least one of the plurality of non-periodic synchronization boundaries. Numerous other aspects are provided.

### CROSS-REFERENCE TO RELATED APPLICATION

This Patent application claims priority to U.S. Provisional Patent Application No. 63/117,373, filed on Nov. 23, 2020, entitled “SYNCHRONIZATION BOUNDARY RANDOMIZATION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for synchronization boundary randomization.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” or “forward link” refers to the communication link from the BS to the UE, and “uplink” or “reverse link” refers to the communication link from the UE to the BS. As will be described in more detail herein, a BS may be referred to as a Node B, a gNB, an access point (AP), a radio head, a transmit receive point (TRP), a New Radio (NR) BS, or a 5G Node B.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE, NR, and other radio access technologies.

### SUMMARY

In some aspects, a method of wireless communication performed by a wireless communication device includes determining a plurality of non-periodic synchronization boundaries for synchronous access of a wireless channel; and communicating on the wireless channel based at least in part on at least one of the plurality of non-periodic synchronization boundaries.

In some aspects, a wireless communication device for wireless communication includes a memory and one or more processors coupled to the memory, the one or more processors configured to determine a plurality of non-periodic synchronization boundaries for synchronous access of a wireless channel; and communicate on the wireless channel based at least in part on at least one of the plurality of non-periodic synchronization boundaries.

In some aspects, a non-transitory computer-readable medium storing a set of instructions for wireless communication includes one or more instructions that, when executed by one or more processors of a wireless communication device, cause the wireless communication device to determine a plurality of non-periodic synchronization boundaries for synchronous access of a wireless channel; and communicate on the wireless channel based at least in part on at least one of the plurality of non-periodic synchronization boundaries.

In some aspects, an apparatus for wireless communication includes means for determining a plurality of non-periodic synchronization boundaries for synchronous access of a wireless channel; and means for communicating on the wireless channel based at least in part on at least one of the plurality of non-periodic synchronization boundaries.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of various types of wireless channel access modes, in accordance with the present disclosure.

FIG. 4 is a diagram illustrating an example associated with synchronization boundary randomization, in accordance with the present disclosure.

FIG. 5 is a diagram illustrating an example process associated with synchronization boundary randomization, in accordance with the present disclosure.

FIG. 6 is a block diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

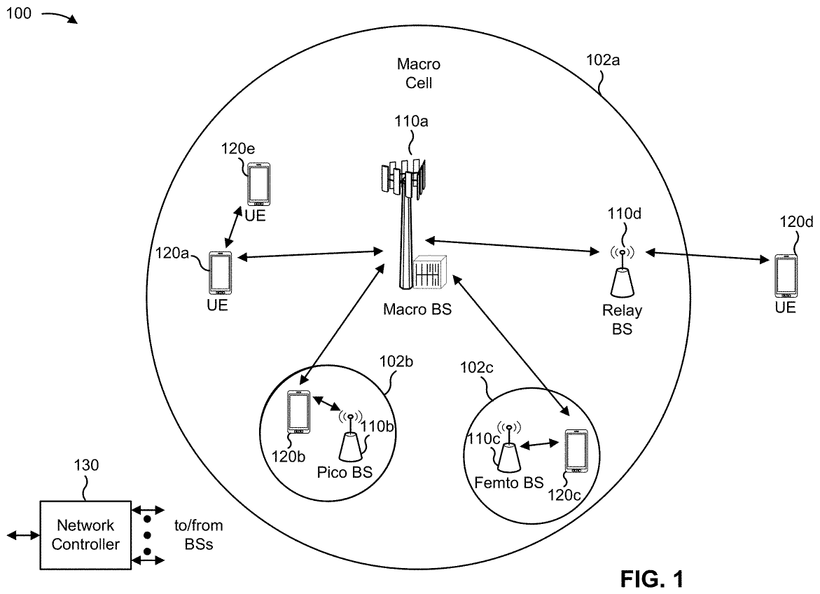

FIG. 1 is a diagram illustrating an example of a wireless network 100 in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, or a transmit receive point (TRP). Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. ABS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, or a virtual network using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, or a relay.

Wireless network 100 may be a heterogeneous network that includes BSs of different types, such as macro BSs, pico BSs, femto BSs, and/or relay BSs. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, directly or indirectly, via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, and/or an air interface. A frequency may also be referred to as a carrier, and/or a frequency channel. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

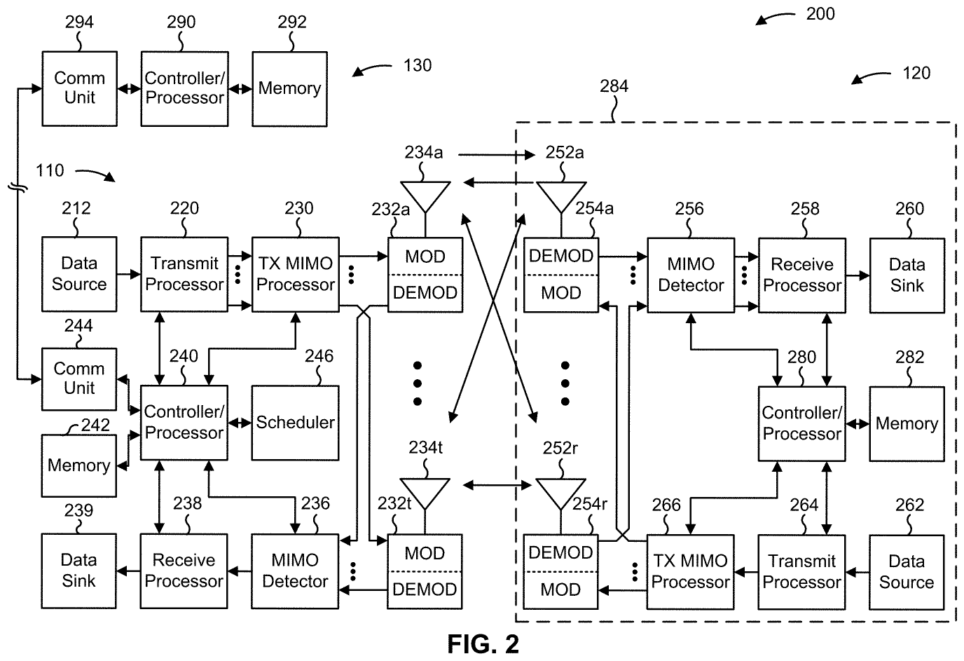

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, upper layer signaling) and provide overhead symbols and control symbols. Transmit processor 220 may also generate reference symbols for reference signals (e.g., a cell-specific reference signal (CRS), a demodulation reference signal (DMRS)) and synchronization signals (e.g., the primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine reference signal received power (RSRP), received signal strength indicator (RSSI), reference signal received quality (RSRQ), and/or CQI, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

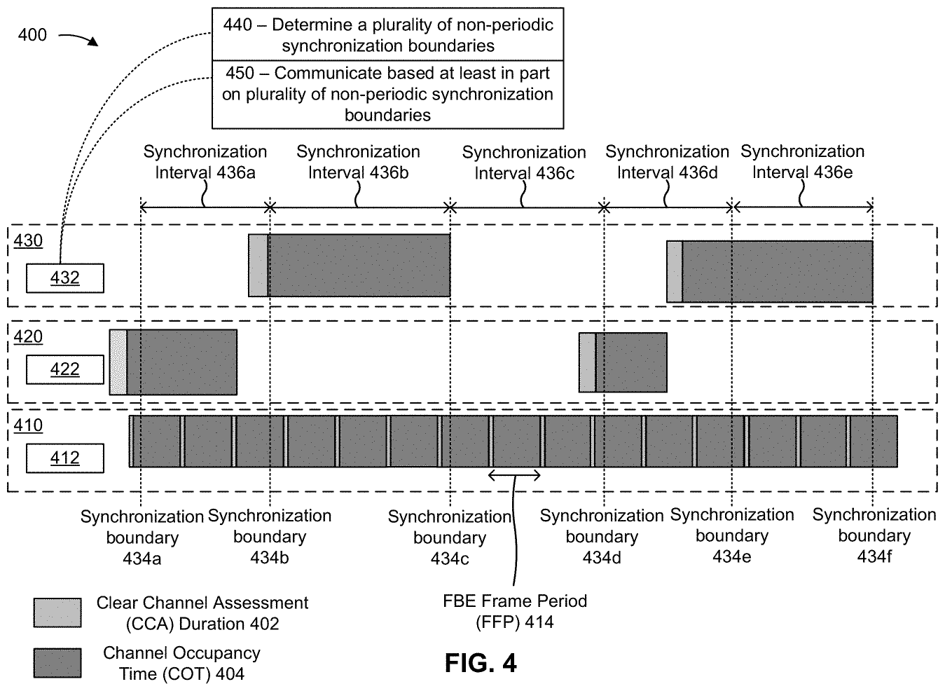

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 4-6).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 4-6).

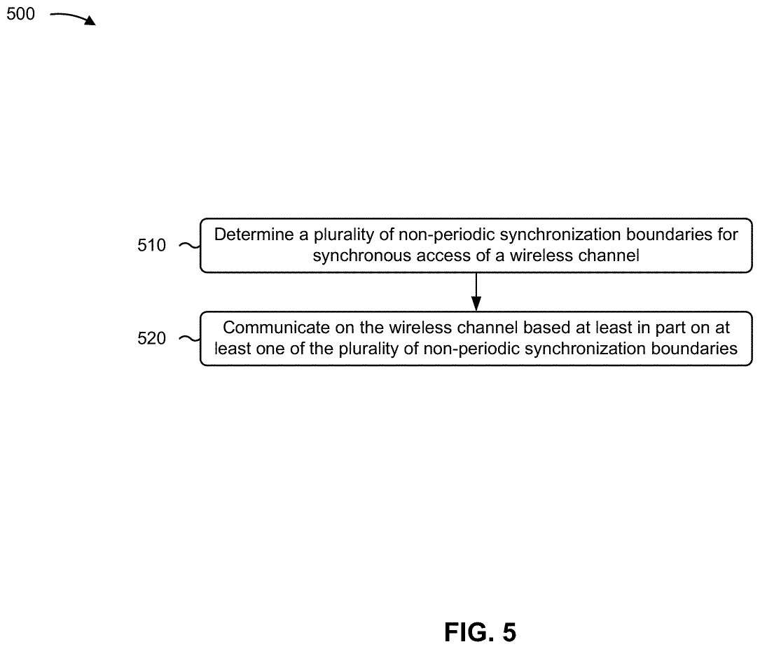

Controller/processor 240 of base station 110, controller/processor 280 of UE 120, and/or any other component(s) of FIG. 2 may perform one or more techniques associated with synchronization boundary randomization, as described in more detail elsewhere herein. In some aspects, the wireless communication device(s) described herein is the base station 110, is included in the base station 110, or includes one or more components of the base station 110 shown in FIG. 2. In some aspects, the wireless communication device(s) described herein is the UE 120, is included in the UE 120, or includes one or more components of the UE 120 shown in FIG. 2. For example, controller/processor 240 of base station 110, controller/processor 280 of UE 120, and/or any other component(s) of FIG. 2 may perform or direct operations of, for example, process 500 of FIG. 5 and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of base station 110 and/or UE 120, may cause the one or more processors, UE 120, and/or base station 110 to perform or direct operations of, for example, process 500 of FIG. 5 and/or other processes as described herein. In some aspects, executing instructions may include running the instructions, converting the instructions, compiling the instructions, and/or interpreting the instructions, among other examples.

In some aspects, the wireless communication device (e.g., the base station 110 or the UE 120) includes means for determining a plurality of non-periodic synchronization boundaries for synchronous access of a wireless channel; and/or means for communicating on the wireless channel based at least in part on at least one of the plurality of non-periodic synchronization boundaries. In some aspects, the means for the wireless communication device to perform operations described herein may include, for example, one or more of transmit processor 220, TX MIMO processor 230, modulator 232, antenna 234, demodulator 232, MIMO detector 236, receive processor 238, controller/processor 240, memory 242, or scheduler 246. In some aspects, the means for the wireless communication device to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, the wireless communication device includes means for determining a plurality of randomized synchronization boundaries. In some aspects, the wireless communication device includes means for coordinating the plurality of non-periodic synchronization boundaries with another wireless communication device. In some aspects, the wireless communication device includes means for transmitting, to the other wireless communication device, an indication of a proposed pseudorandom number generator configuration for determining the plurality of non-periodic synchronization boundaries. In some aspects, the wireless communication device includes means for determining the plurality of non-periodic synchronization boundaries based at least in part on a pseudorandom number generator configuration that is coordinated between the wireless communication device and the other wireless communication device. In some aspects, the wireless communication device includes means for accessing the wireless channel based at least in part on the plurality of non-periodic synchronization boundaries such that an average duration of load-based equipment channel occupancy times of the wireless channel satisfies a threshold.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

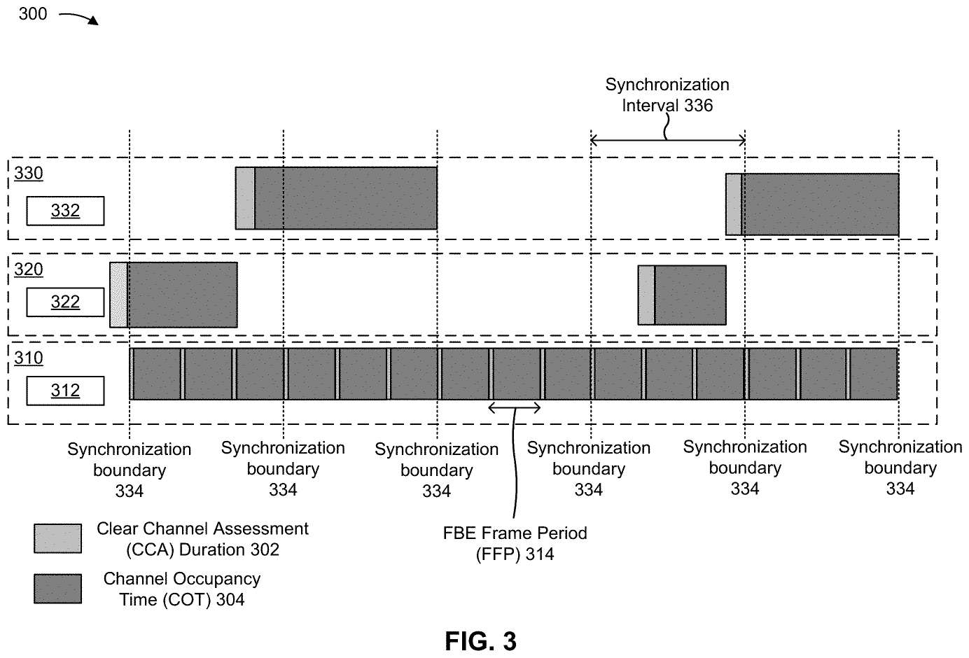

FIG. 3 is a diagram illustrating an example 300 of various types of wireless channel access modes, in accordance with various aspects of the present disclosure. The wireless channel access modes may include wireless channel access modes for accessing a wireless channel in an unlicensed frequency band (e.g., a 6 gigahertz frequency band), which may also be referred to as a shared spectrum frequency band. Accordingly, the example wireless channel access modes illustrated in FIG. 3 may be used in connection with NR unlicensed (NR-U), Wi-Fi, and/or other communications systems involving the use of unlicensed frequency bands. A wireless communication device operating in a particular wireless channel access mode may perform a clear channel assessment (CCA) (or another listen before talk (LBT) technique) during a CCA duration 302 to access the wireless channel for a channel occupancy time (COT) 304. During a COT 304, a wireless communication device may transmit communications, may receive communications, or a combination thereof.

As shown in FIG. 3, example wireless channel access mode 310 may include a frame-based equipment (FBE) mode. A wireless communication device 312 (e.g., a base station 110 or a UE 120) operating in an FBE mode may operate according to a transmit/receive structure that is not directly demand-driven. In this wireless channel access mode, the wireless communication device 312 may perform a CCA for a CCA duration 302, and may access a wireless channel for a COT 304 based on periodic FBE frame periods (FFPs) 314. The period of the FFPs 314 is a fixed duration and may be selected from a range of approximately 1 millisecond (ms) to approximately 10 ms.

The wireless communication device 312 may determine whether the wireless channel is clear (or idle) by sensing or measuring the energy level on the wireless channel for the CCA duration 302 (e.g., 20 microseconds or greater). The wireless communication device 312 may determine that the channel is clear or idle based at least in part on determining that the energy level on the wireless channel does not satisfy a threshold, and may determine that the channel is busy or occupied based at least in part on determining that the energy level on the wireless channel satisfies the threshold.

The wireless communication device 312 may be permitted to transmit for the duration of a COT 304 based on determining that the wireless channel is clear after performing the CCA. However, if the wireless communication device 312 cannot complete the transmission in a single COT 304, the wireless communication device 312 is to perform another CCA in a subsequent CCA duration 302 to regain access of the wireless channel for another COT 304 to complete the transmission.

As further shown in FIG. 3, an example wireless access mode 320 may include a load-based equipment (LBE) asynchronous mode. A wireless communication device 322 (e.g., a base station 110 or a UE 120) operating in an LBE asynchronous mode may operate according to a transmit/receive structure that is primarily demand-driven (or load-driven). In this wireless channel access mode, the wireless communication device 322 attempts to access a wireless channel based on a transmit/receive load of the wireless communication device 322. A wireless communication device that operates in an LBE asynchronous mode may be referred to as an LBE asynchronous node. If the wireless communication device 322 has a communication to transmit or receive, the wireless communication device 322 may attempt to access the wireless channel at any time. Similar to the wireless communication device 312 described above, the wireless communication device 322 may perform a CCA for a CCA duration 302 to attempt to access the channel for a COT 304. The duration of a COT 304 in the LBE asynchronous mode may be equal to or less than a particular duration, such as 6 ms.

As further shown in FIG. 3, an example wireless access mode 330 may include an LBE synchronous mode. A wireless communication device 332 (e.g., a base station 110 or a UE 120) operating in an LBE synchronous mode may access a wireless channel in a demand-driven (or load-driven) manner similar to the LBE asynchronous mode. However, the wireless communication device 332 operating in the LBE synchronous mode may synchronize access to a wireless channel with other wireless communication devices operating in an LBE synchronous by performing CCAs at or near synchronization boundaries 334, and by ending of COTs 304 at synchronization boundaries 334. A wireless communication device that operates in an LBE synchronous mode may be referred to as an LBE synchronous node. The synchronization boundaries 334 (or synchronization reference boundaries) may be defined in a wireless communication standard or specification such that the LBE synchronous nodes may identify and conform operation to the synchronization boundaries 334. In some aspects, the synchronization boundaries 334 are based on coordinated universal time (UTC) or another easily-referenceable and standardized time. The duration between synchronization boundaries 334 may be periodic (e.g., such that synchronization boundaries 334 repeat every 6 ms) and may be referred to as a synchronization interval 336.

The time-synchronized wireless channel access techniques of the LBE synchronous mode may enable advanced spectrum sharing techniques that use highly flexible, spatial sharing to provide more predictable access and, thus, improved throughput and latency. For example, the LBE synchronous mode may permit the wireless communication device 332 (and other LBE synchronous nodes) to extend COT durations beyond the 6 ms of LBE synchronous nodes (e.g., to 12 ms or more), which reduces the quantity of CCAs that the wireless communication device 332 may need to perform to complete a transmission. As another example, the time-synchronous structure of the LBE synchronous mode may enable coordinated multi-point (CoMP) techniques for ultra-low latency IoT implementations in unlicensed frequency bands.

In some aspects, a wireless communication device may switch between two or more wireless channel access modes. For example, a wireless communication device may switch between operating in an LBE synchronous mode and an LBE asynchronous mode to increase the capability of the wireless communication device to obtain access to a wireless channel for a COT. As another example, a wireless communication device may prioritize operation in an LBE synchronous mode to obtain the above-described efficiency gains of synchronous access and may fall back to an LBE asynchronous mode in various situations to increase the likelihood that the wireless communication device will obtain access to a wireless channel for a COT.

As indicated above, FIG. 3 is provided as an example. Other examples may differ from what is described with regard to FIG. 3.

Different types of wireless channel access modes may be in operation on a wireless channel in a wireless network. For example, a first subset of wireless communication devices may operate in an FBE mode, a second subset of wireless communication devices may operate in an LBE asynchronous mode, and a third subset of wireless communication devices may operate in an LBE synchronous mode. While permitting the operation of different types of wireless channel access modes on a wireless channel provides flexibility in channel access, some types of wireless channel access modes may cause operational issues with other types of wireless channel access modes. For example, the periodic synchronization intervals of an LBE synchronous mode may be configured in a way that results in synchronization boundaries aligning or overlapping with the beginning of FBE frame periods of an FBE mode. This can cause difficulties for LBE synchronous nodes when attempting to access the wireless channel because of the relatively longer back-off time used by LBE synchronous nodes. In particular, an FBE node may access the wireless channel after determining that the wireless channel is clear for a single CCA slot, whereas an LBE synchronous node may access the wireless channel after determining that the wireless channel is clear for a plurality of consecutive CCA slots. As a result, the FBE node may opportunistically access the wireless channel at or near the synchronization boundaries to reliably gain access to the wireless channel, which can reduce the ability of the LBE synchronous node to gain access to the wireless channel. This can result in communication delays for the LBE synchronous node, which can further result in an inability to support ultra-reliable low-latency communication (URLLC) and other quality of service (QoS) parameters.

Some aspects described herein provide techniques and apparatuses for synchronization boundary randomization. As described herein, LBE synchronous nodes may determine non-periodic synchronization boundaries for an LBE synchronous mode and may communicate based at least in part on the non-periodic synchronization boundaries. The non-periodic synchronization boundaries may reduce and/or eliminate the likelihood that a synchronization boundary will align or overlap with an FBE frame period of an FBE mode in deployment on the same wireless channel. This increases the ability of the LBE synchronous nodes to access the wireless channel, decreases the likelihood that FBE nodes will starve the LBE synchronous nodes of access to the wireless channel, and/or may reduce communication delays for the LBE synchronous nodes.

FIG. 4 is a diagram illustrating an example 400 associated with synchronization boundary randomization, in accordance with the present disclosure. As shown in FIG. 4, example 400 includes one or more wireless communication devices (e.g., one or more base stations 110 and/or one or more UEs 120). In some aspects, the wireless communication devices may be included in a wireless network such as wireless network 100.

The wireless communication devices may be configured to communicate on a wireless channel and on a frequency band. In some aspects, the frequency band is an unlicensed frequency band and/or a shared spectrum frequency band such as a 6 gigahertz frequency band. Accordingly, a wireless communication device may perform a CCA for a CCA duration 402 in order to contend for access of the wireless channel and may transmit and/or receive on the wireless channel for an associated COT 404 if access to the wireless channel is gained.

As shown in FIG. 4, the wireless communication devices may operate in one or more wireless channel access modes, such as a wireless channel access mode 410, a wireless channel access mode 420, and/or a wireless channel access mode 430. A wireless communication device 412 operating in the wireless channel access mode 410 may operate according to the FBE mode described above in FIG. 3, in which the wireless communication device 412 contends for access of the wireless channel and communicates on the wireless channel based at least in part on fixed FBE frame periods 414. A wireless communication device 422 operating in the wireless channel access mode 420 may operate according to the LBE asynchronous mode described above in FIG. 3. A wireless communication device 432 operating in the wireless channel access mode 420 may operate according to the LBE synchronous mode described above in FIG. 3, in which the wireless communication device 432 contends for access of the wireless channel and communicates on the wireless channel based at least in part on synchronization boundaries 434 and synchronization intervals 436.

As shown in FIG. 4, and by reference number 440, the wireless communication device 432 (e.g., the wireless communication device operating in the LBE synchronous mode) may determine a plurality of non-periodic synchronization boundaries 434. The non-periodic synchronization boundaries 434 may include synchronization boundaries that do not occur or repeat at a particular period or time interval. Thus, the resulting synchronization intervals 436 between the non-periodic synchronization boundaries 434 may be variable, non-uniform, or unequal in duration. For example, the time duration between synchronization boundary 434a and synchronization boundary 434b (e.g., synchronization interval 436a) may be different from (e.g., longer or shorter in duration) the time duration between the synchronization boundary 434b and synchronization boundary 434c (e.g., synchronization interval 436b), the time duration between the synchronization boundary 434b and the synchronization boundary 434c (e.g., the synchronization interval 436b) may be different from the time duration between the synchronization boundary 434c and synchronization boundary 434d (e.g., synchronization interval 436c), the time duration between the synchronization boundary 434c and the synchronization boundary 434d (e.g., the synchronization interval 436b) may be different from the time duration between the synchronization boundary 434d and synchronization boundary 434e (e.g., synchronization interval 436c), the time duration between the synchronization boundary 434d and the synchronization boundary 434e (e.g., the synchronization interval 436d) may be different from the time duration between the synchronization boundary 434e and synchronization boundary 434f (e.g., synchronization interval 436d), and so on.

As shown in FIG. 4, because the FBE frame periods 414 are of a fixed period or duration, determining the plurality of non-periodic synchronization boundaries 434 such that the associated synchronization intervals 436 are non-uniform may reduce and/or prevent alignment or overlap of the non-periodic synchronization boundaries 434 with the FBE frame periods 414 of FBE nodes operating in the FBE mode (such as the wireless communication device 412). In some aspects, to further reduce and/or prevent alignment or overlap of the non-periodic synchronization boundaries 434 with the FBE frame periods 414, the wireless communication device 432 may determine the non-periodic synchronization boundaries 434 such that the non-periodic synchronization boundaries 434 are pseudorandomized synchronous nodes or randomized synchronous nodes.

In some aspects, the wireless communication device 432 may determine the non-periodic synchronization boundaries 434 using a pseudorandom number generator, using a random number generator, and/or using another technique for determining pseudorandom or random numbers (which may correspond to the time locations of the non-periodic synchronization boundaries 434 or the time durations of the synchronization intervals 436 between the non-periodic synchronization boundaries 434). In some aspects, the wireless communication device 432 determines or selects one or more inputs and/or pseudorandom number generator configuration parameters for the pseudorandom number generator based at least in part on a global standard (e.g., a wireless communication standard or a wireless communication specification). The one or more inputs and/or pseudorandom number generator configuration parameters may include, for example, a starting time for the non-periodic synchronization boundaries 434 (e.g., which may correspond to a particular UTC time), a quantity of synchronization boundaries that are to be determined, the type of pseudorandom number generator algorithm that is to be used, the initial value or seed that is to be used in the pseudorandom number generator, and/or the like.

In some aspects, the wireless communication device 432 coordinates the plurality of non-periodic synchronization boundaries with one or more other LBE synchronous nodes. In these examples, the wireless communication device 432 determines or selects the one or more inputs and/or pseudorandom number generator configuration parameters for determining the plurality of non-periodic synchronization boundaries 434 based at least in part on the implementation of the wireless communication device 432 or on local coordination with other LBE synchronous nodes.

For example, the wireless communication device 432 may transmit, to another LBE synchronous node, an indication of a proposed pseudorandom number generator configuration for determining the plurality of non-periodic synchronization boundaries 434. The other LBE synchronous node may accept the proposed pseudorandom number generator configuration or may reject the proposed pseudorandom number generator configuration and may transmit a counter-proposal of another proposed pseudorandom number generator configuration. The wireless communication device 432 may accept or reject the counter-proposal, and/or may transmit another counter-proposal to the other LBE synchronous node. The wireless communication device 432 and the other LBE synchronous node may continue coordinating the pseudorandom number generator configuration until an agreement is reached. In some aspects, another LBE synchronous node may initiate coordination of the pseudorandom number generator configuration with the wireless communication device 432. The wireless communication device 432 (and the other LBE synchronous node) may determine the plurality of non-periodic synchronization boundaries 434 based at least in part on the coordinated pseudorandom number generator configuration.

As further shown in FIG. 4, and by reference number 450, the wireless communication device 432 may communicate on the wireless channel based at least in part on the non-periodic synchronization boundaries 434. For example, the wireless communication device 432 may contend for access of the wireless channel during a CCA duration 402 at or near a non-periodic synchronization boundary 434, may occupy the wireless channel for a COT 404 that ends at a non-periodic synchronization boundary 434, may extend a duration of a COT 404 based at least in part on a synchronization interval 436 (with the extended COT 404 ending at a non-periodic synchronization boundary 434), and/or the like. In some aspects, the wireless communication device 432 may perform COT extension of one or more COTs 404 based at least in part on the non-periodic synchronization boundaries 434 and may access the wireless channel based at least in part on the non-periodic synchronization boundaries 434 such that an average duration of LBT COTs for the wireless communication device 432 satisfies a threshold average duration (e.g., 6 ms, 12 ms, or other durations).

In some aspects, the wireless communication device 432 is a supervising node. “Supervising node” may refer to a wireless communication device that supervises, coordinates, and/or controls the operation of one or more supervised nodes. For example, a supervising node may include a wireless access point or a base station 110, and a supervised node may include a UE 120. In these examples, the wireless communication device 432 may transmit an indication of the plurality of non-periodic synchronization boundaries 434 (or the one or more inputs and/or pseudorandom number generator parameters for determining the plurality of non-periodic synchronization boundaries 434) to one or more supervised nodes. In this way, the one or more supervised nodes may also access and communicate on the wireless channel based at least in part on the plurality of non-periodic synchronization boundaries 434.

As indicated above, FIG. 4 is provided as an example. Other examples may differ from what is described with respect to FIG. 4.

FIG. 5 is a diagram illustrating an example process 500 performed, for example, by a wireless communication device, in accordance with the present disclosure. Example process 500 is an example where the wireless communication device (e.g., a base station 110, a UE 120) performs operations associated with synchronization boundary randomization.

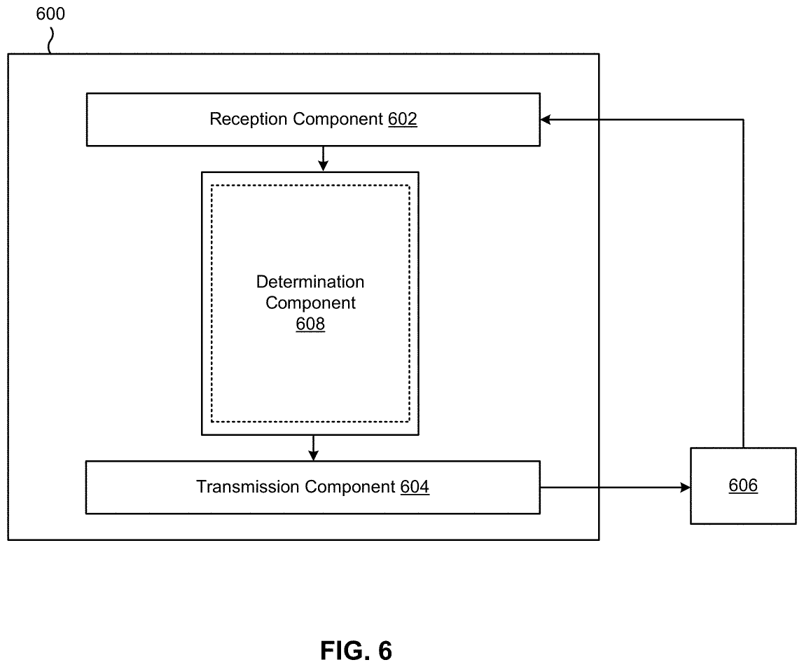

As shown in FIG. 5, in some aspects, process 500 may include determining a plurality of non-periodic synchronization boundaries for synchronous access of a wireless channel (block 510). For example, the wireless communication device (e.g., using determination component 608, depicted in FIG. 6) may determine a plurality of non-periodic synchronization boundaries for synchronous access of a wireless channel, as described above.

As further shown in FIG. 5, in some aspects, process 500 may include communicating on the wireless channel based at least in part on at least one of the plurality of non-periodic synchronization boundaries (block 520). For example, the wireless communication device (e.g., using reception component 602 and/or transmission component 604, depicted in FIG. 6) may communicate on the wireless channel based at least in part on at least one of the plurality of non-periodic synchronization boundaries, as described above.

Process 500 may include additional aspects, such as any single aspect or any combination of aspects described below and/or in connection with one or more other processes described elsewhere herein.

In a first aspect, the wireless communication device comprises a supervising node or a UE. In a second aspect, alone or in combination with the first aspect, the wireless communication device is configured to communicate over an unlicensed frequency band. In a third aspect, alone or in combination with one or more of the first and second aspects, the wireless communication device is configured to operate in a synchronous access mode. In a fourth aspect, alone or in combination with one or more of the first through third aspects, the wireless communication device comprises a load-based equipment synchronous access node. In a fifth aspect, alone or in combination with one or more of the first through fourth aspects, determining the plurality of non-periodic synchronization boundaries comprises determining a plurality of randomized synchronization boundaries.

In a sixth aspect, alone or in combination with one or more of the first through fifth aspects, determining the plurality of non-periodic synchronization boundaries comprises coordinating the plurality of non-periodic synchronization boundaries with another wireless communication device. In a seventh aspect, alone or in combination with one or more of the first through sixth aspects, coordinating the plurality of non-periodic synchronization boundaries with the other wireless communication device comprises transmitting, to the other wireless communication device, an indication of a proposed pseudorandom number generator configuration for determining the plurality of non-periodic synchronization boundaries.

In an eighth aspect, alone or in combination with one or more of the first through seventh aspects, coordinating the plurality of non-periodic synchronization boundaries with the other wireless communication device comprises determining the plurality of non-periodic synchronization boundaries based at least in part on a pseudorandom number generator configuration that is coordinated between the wireless communication device and the other wireless communication device. In a ninth aspect, alone or in combination with one or more of the first through eighth aspects, communicating on the wireless channel based at least in part on at least one of the plurality of non-periodic synchronization boundaries comprises accessing the wireless channel based at least in part on the plurality of non-periodic synchronization boundaries such that an average duration of load-based equipment channel occupancy times of the wireless channel satisfies a threshold.

In a tenth aspect, alone or in combination with one or more of the first through ninth aspects, communicating on the wireless channel based at least in part on at least one of the plurality of non-periodic synchronization boundaries comprises contending for the wireless channel in a synchronous manner with one or more other wireless communication devices at or near at least one of the plurality of non-periodic synchronization boundaries.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a block diagram of an example apparatus 600 for wireless communication. The apparatus 600 may be a wireless communication device (e.g., a base station 110 or a UE 120), or a wireless communication device may include the apparatus 600. In some aspects, the apparatus 600 includes a reception component 602 and a transmission component 604, which may be in communication with one another (for example, via one or more buses and/or one or more other components). As shown, the apparatus 600 may communicate with another apparatus 606 (such as a UE, a base station, or another wireless communication device) using the reception component 602 and the transmission component 604. As further shown, the apparatus 600 may include a determination component 608.

In some aspects, the apparatus 600 may be configured to perform one or more operations described herein in connection with FIG. 4. Additionally, or alternatively, the apparatus 600 may be configured to perform one or more processes described herein, such as process 500 of FIG. 5. In some aspects, the apparatus 600 and/or one or more components shown in FIG. 6 may include one or more components of the wireless communication device described above in connection with FIG. 2. Additionally, or alternatively, one or more components shown in FIG. 6 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 602 may receive communications, such as reference signals, control information, data communications, or a combination thereof, from the apparatus 606. The reception component 602 may provide received communications to one or more other components of the apparatus 600. In some aspects, the reception component 602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 606. In some aspects, the reception component 602 may include one or more antennas, a demodulator, a MIMO detector, a receive processor, a controller/processor, a memory, or a combination thereof, of the base station 110 and/or the UE 120 described above in connection with FIG. 2.

The transmission component 604 may transmit communications, such as reference signals, control information, data communications, or a combination thereof, to the apparatus 606. In some aspects, one or more other components of the apparatus 606 may generate communications and may provide the generated communications to the transmission component 604 for transmission to the apparatus 606. In some aspects, the transmission component 604 may perform signal processing on the generated communications (such as filtering, amplification, modulation, digital-to-analog conversion, multiplexing, interleaving, mapping, or encoding, among other examples), and may transmit the processed signals to the apparatus 606. In some aspects, the transmission component 604 may include one or more antennas, a modulator, a transmit MIMO processor, a transmit processor, a controller/processor, a memory, or a combination thereof, of the base station 110 and/or the UE 120 described above in connection with FIG. 2. In some aspects, the transmission component 604 may be co-located with the reception component 602 in a transceiver.

The determination component 608 may determine a plurality of non-periodic synchronization boundaries for synchronous access of a wireless channel. The reception component 602 and/or the transmission component 604 may communicate with the apparatus 606 on the wireless channel based at least in part on at least one of the plurality of non-periodic synchronization boundaries.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

The following provides an overview of aspects of the present disclosure:

Aspect 1: A method of wireless communication performed by a wireless communication device, comprising: determining a plurality of non-periodic synchronization boundaries for synchronous access of a wireless channel; and communicating on the wireless channel based at least in part on at least one of the plurality of non-periodic synchronization boundaries.

Aspect 2: The method of aspect 1, wherein the wireless communication device comprises a supervising node or a UE. Aspect 3: The method of aspect 1 or 2, wherein the wireless communication device is configured to communicate over an unlicensed frequency band. Aspect 4: The method of any of aspects 1-3, wherein the wireless communication device is configured to operate in a synchronous access mode. Aspect 5: The method of any of aspects 1-4, wherein the wireless communication device comprises a load-based equipment synchronous access node.

Aspect 6: The method of any of aspects 1-5, wherein determining the plurality of non-periodic synchronization boundaries comprises: determining a plurality of randomized synchronization boundaries. Aspect 7: The method of any of aspects 1-6, wherein determining the plurality of non-periodic synchronization boundaries comprises: coordinating the plurality of non-periodic synchronization boundaries with another wireless communication device.

Aspect 8: The method of aspect 7, wherein coordinating the plurality of non-periodic synchronization boundaries with the other wireless communication device comprises: transmitting, to the other wireless communication device, an indication of a proposed pseudorandom number generator configuration for determining the plurality of non-periodic synchronization boundaries. Aspect 9: The method of aspect 7 or 8, wherein coordinating the plurality of non-periodic synchronization boundaries with the other wireless communication device comprises: determining the plurality of non-periodic synchronization boundaries based at least in part on a pseudorandom number generator configuration that is coordinated between the wireless communication device and the other wireless communication device.

Aspect 10: The method of any of aspects 1-9, wherein communicating on the wireless channel based at least in part on at least one of the plurality of non-periodic synchronization boundaries comprises: accessing the wireless channel based at least in part on the plurality of non-periodic synchronization boundaries such that an average duration of load-based equipment channel occupancy times of the wireless channel satisfies a threshold.

Aspect 11: The method of any of aspects 1-10, wherein communicating on the wireless channel based at least in part on at least one of the plurality of non-periodic synchronization boundaries comprises: contending for the wireless channel in a synchronous manner with one or more other wireless communication devices at or near at least one of the plurality of non-periodic synchronization boundaries.

Aspect 12: An apparatus for wireless communication at a device, comprising a processor; memory coupled with the processor; and instructions stored in the memory and executable by the processor to cause the apparatus to perform the method of one or more aspects of aspects 1-11. Aspect 13: A device for wireless communication, comprising a memory and one or more processors coupled to the memory, the one or more processors configured to perform the method of one or more aspects of aspects 1-11.

Aspect 14: An apparatus for wireless communication, comprising at least one means for performing the method of one or more aspects of aspects 1-11. Aspect 15: A non-transitory computer-readable medium storing code for wireless communication, the code comprising instructions executable by a processor to perform the method of one or more aspects of aspects 1-11.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware, firmware, and/or a combination of hardware and software.

It will be apparent that systems and/or methods described herein may be implemented in different forms of hardware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, a combination of related and unrelated items), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a wireless communication device, comprising:
determining a plurality of non-periodic synchronization boundaries for synchronous access of a wireless channel; and
communicating on the wireless channel based at least in part on at least one of the plurality of non-periodic synchronization boundaries.

2. The method of claim 1, wherein the wireless communication device comprises a supervising node or a user equipment (UE).

3. The method of claim 1, wherein the wireless communication device is configured to communicate over an unlicensed frequency band.

4. The method of claim 1, wherein the wireless communication device is configured to operate in a synchronous access mode.

5. The method of claim 1, wherein the wireless communication device comprises a load-based equipment synchronous node.

6. The method of claim 1, wherein determining the plurality of non-periodic synchronization boundaries comprises:
determining a plurality of randomized synchronization boundaries.

7. The method of claim 1, wherein determining the plurality of non-periodic synchronization boundaries comprises:
coordinating the plurality of non-periodic synchronization boundaries with another wireless communication device.

8. The method of claim 7, wherein coordinating the plurality of non-periodic synchronization boundaries with the other wireless communication device comprises:
transmitting, to the other wireless communication device, an indication of a proposed pseudorandom number generator configuration for determining the plurality of non-periodic synchronization boundaries.

9. The method of claim 7, wherein coordinating the plurality of non-periodic synchronization boundaries with the other wireless communication device comprises:
determining the plurality of non-periodic synchronization boundaries based at least in part on a pseudorandom number generator configuration that is coordinated between the wireless communication device and the other wireless communication device.

10. The method of claim 1, wherein communicating on the wireless channel based at least in part on at least one of the plurality of non-periodic synchronization boundaries comprises:
accessing the wireless channel based at least in part on the plurality of non-periodic synchronization boundaries such that an average duration of load-based equipment channel occupancy times of the wireless channel satisfies a threshold.

11. The method of claim 1, wherein communicating on the wireless channel based at least in part on at least one of the plurality of non-periodic synchronization boundaries comprises:
contending for the wireless channel in a synchronous manner with one or more other wireless communication devices at or near at least one of the plurality of non-periodic synchronization boundaries.

12. A wireless communication device for wireless communication, comprising:
a memory; and
one or more processors, coupled to the memory, configured to:
determine a plurality of non-periodic synchronization boundaries for synchronous access of a wireless channel; and
communicate on the wireless channel based at least in part on at least one of the plurality of non-periodic synchronization boundaries.

13. The wireless communication device of claim 12, wherein the wireless communication device comprises a supervising node or a user equipment (UE).

14. The wireless communication device of claim 12, wherein the wireless communication device is configured to communicate over an unlicensed frequency band.

15. The wireless communication device of claim 12, wherein the wireless communication device is configured to operate in a synchronous access mode.

16. The wireless communication device of claim 12, wherein the wireless communication device comprises a load-based equipment synchronous node.

17. The wireless communication device of claim 12, wherein the one or more processors, to determine the plurality of non-periodic synchronization boundaries, are configured to:
determine a plurality of randomized synchronization boundaries.

18. The wireless communication device of claim 12, wherein the one or more processors, to determine the plurality of non-periodic synchronization boundaries, are configured to:
coordinate the plurality of non-periodic synchronization boundaries with another wireless communication device.

19. The wireless communication device of claim 18, wherein the one or more processors, to coordinate the plurality of non-periodic synchronization boundaries with the other wireless communication device, are configured to:
transmit, to the other wireless communication device, an indication of a proposed pseudorandom number generator configuration for determining the plurality of non-periodic synchronization boundaries.

20. The wireless communication device of claim 18, wherein the one or more processors, to coordinate the plurality of non-periodic synchronization boundaries with the other wireless communication device, are configured to:
determine the plurality of non-periodic synchronization boundaries based at least in part on a pseudorandom number generator configuration that is coordinated between the wireless communication device and the other wireless communication device.

21. The wireless communication device of claim 12, wherein the one or more processors, to communicate on the wireless channel based at least in part on at least one of the plurality of non-periodic synchronization boundaries, are configured to:
access the wireless channel based at least in part on the plurality of non-periodic synchronization boundaries such that an average duration of load-based equipment channel occupancy times of the wireless channel satisfies a threshold.

22. The wireless communication device of claim 12, wherein the one or more processors, to communicate on the wireless channel based at least in part on at least one of the plurality of non-periodic synchronization boundaries, are configured to:
contend for the wireless channel in a synchronous manner with one or more other wireless communication devices at or near at least one of the plurality of non-periodic synchronization boundaries.

23. A non-transitory computer-readable medium storing a set of instructions for wireless communication, the set of instructions comprising:
one or more instructions that, when executed by one or more processors of a wireless communication device, cause the wireless communication device to:
determine a plurality of non-periodic synchronization boundaries for synchronous access of a wireless channel; and
communicate on the wireless channel based at least in part on at least one of the plurality of non-periodic synchronization boundaries.

24. The non-transitory computer-readable medium of claim 23, wherein the wireless communication device comprises a supervising node or a user equipment (UE).

25. The non-transitory computer-readable medium of claim 23, wherein the one or more instructions further cause the wireless communication device to communicate over an unlicensed frequency band.

26. The non-transitory computer-readable medium of claim 23, wherein the one or more instructions further cause the wireless communication device to operate in a synchronous access mode.

27. An apparatus for wireless communication, comprising:
means for determining a plurality of non-periodic synchronization boundaries for synchronous access of a wireless channel; and
means for communicating on the wireless channel based at least in part on at least one of the plurality of non-periodic synchronization boundaries.

28. The apparatus of claim 27, wherein the apparatus comprises a supervising node or a user equipment (UE).

29. The apparatus of claim 27, further comprising means for communicating over an unlicensed frequency band.

30. The apparatus of claim 27, further comprising means for operating in a synchronous access mode.
